(19) United States
(12) Patent Application Publication
(10) Pub. No.: US 2004/0210773 A1
(43) Pub. Date: Oct. 21, 2004

(54) System and method for network security

(76) Inventor: Charles Markosi III, Lakewood Ranch, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/826,822

(22) Filed: Apr. 16, 2004

Related U.S. Application Data
(60) Provisional application No. 60/463,268, filed on Apr. 16, 2003.

(51) Int. Cl. G06F 11/30; G06F 15/173

(52) U.S. Cl. 713/201; 709/224

(57) ABSTRACT

The present invention provides a system and method for use in combination with an Internet service provider or as a standalone system inside corporate boundaries for monitoring electronic communications conducted via the Internet/Intranet. The Internet service provider is provided in communication with a server for storing portions of electronic communications that are determined to be inappropriate based on predetermined criteria. The system allows for Internet/Intranet communications to be automatically and continuously monitored, and allows for predetermined entities to be automatically alerted when the monitored communications are determined to be inappropriate based on predetermined criteria.

### RELATED APPLICATION

The present application claims the benefit of U.S. Provisional Application Serial No. 60/463,268 filed Apr. 16, 2003.

### FIELD OF THE INVENTION

The present invention is directed to an Internet security system. More particularly, the invention is directed to a security system for monitoring electronic communications between a user interface and any physical network.

### BACKGROUND OF THE INVENTION

The unrestricted and public transmission of material and ideas is one of the hallmarks of the Internet. Unfortunately, these inherent strengths of the online world are also often regarded as one of the Internet's greatest weaknesses. For example, the ability to easily obtain adult material is often cited by parent groups as a very significant problem with the online world. As a result, various systems have been developed in an effort to monitor and control access to online materials.

However, while the monitoring of static online material such as pictures and the like is important, of still greater concern is the ability of people to directly communicate with each other. In online forums (e.g., Internet chat rooms, instant messages), where the participants are typically anonymous or have created fake identities, all participants are permitted to discuss events in writing and in real time. This direct link between participants creates the obvious and real danger that individuals participating in these online communications may attempt to contact children and then lure them into harm's way.

Additionally, it is known that modern day terrorists use the Internet to communicate and to plan attacks in attempts to subvert national security. It is appreciated that many of these types of communications go virtually unnoticed only to be revealed after a planned attack has been executed.

On the corporate front, faster, cheaper, and wholly networked portable computers have provided companies with the tools to network employees and to provide global resource access, thus making for a virtual workplace. While, on the one hand, this can provide a critical competitive position, it also provides unprecedented exposure to corporate espionage and intellectual property theft.

Therefore, there is a need for a system that monitors electronic communications (e.g., e-mail, Internet chat rooms and instant messages) and permits an administrator to notify authorities of any suspicious behavior on the part of any participant to the communication.

### SUMMARY OF THE INVENTION

The present invention provides a system and method for use in combination with an Internet service provider, or as a standalone system used in corporate environments, for monitoring electronic communications conducted via the Internet or Intranet. The Internet service provider or corporate entity is provided in communication with a server for storing communications that are determined to be inappropriate based on predetermined criteria. The system allows for Internet/Intranet communications to be automatically and continuously monitored, and allows for predetermined entities to be automatically alerted when the monitored communications are determined to be inappropriate based on predetermined criteria.

The system includes a user interface in communication with the Internet service provider or corporation whereby communications between a user and at least one other party is facilitated via the Internet/Intranet.

A software program employed by the Internet service provider or corporation is operative to monitor the electronic communications between the user interface and the Internet/Intranet and to cause the electronic communications corresponding to inappropriate communications to be sent to the server when the monitored communications satisfy a predetermined criteria. The server stores the portion of the electronic communications and thereafter automatically generates a violation notice regarding the monitored communications considered to be inappropriate.

A content administrator is in communication with the server for receiving the violation notice and for accessing the stored electronic communications that are determined to be inappropriate based on the predetermined criteria. The system permits the content administrator to send complaint information to the authorities when the content administrator determines that the stored electronic communications are in fact considered inappropriate communications upon review.

The present invention provides the advantage of providing a user with a means for being alerted automatically to inappropriate communications being conducted between a user interface and the Internet/Intranet. In this manner communications related to criminal conduct or planning can be realized before harm occurs. Additionally, the user is allowed to selectively alert legal authorities of the potential criminal conduct for further investigation without the parties being aware that the authorities have been notified.

### BRIEF DESCRIPTION OF THE DRAWINGS

A better understanding of the present invention will be had upon reference to the following detailed description when read in conjunction with the accompanying drawings in which like parts are given like reference numerals and wherein:

FIG. 1 is a diagrammatic view of the Internet security system as according to the invention;

FIG. 2 is a process flow diagram of a preferred embodiment of the Internet security system as according to the invention;

FIG. 3 illustrates a diagrammatic view of an alternative embodiment of the Internet security system as according to the invention; and

FIG. 4 illustrates a process flow diagram of the alternative embodiment of the Internet security system as according to the invention.

### DETAILED DESCRIPTION OF THE INVENTION

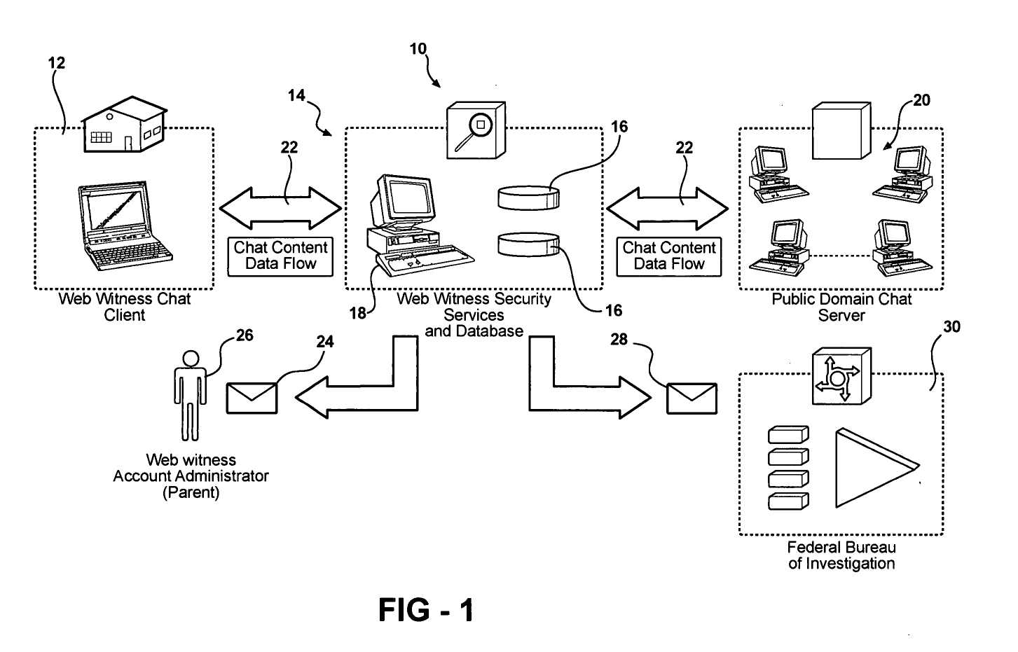

Referring to FIG. 1, there is shown a preferred embodiment of an Internet security system 10 as according to the invention. Preferably the Internet security system 10 includes a user interface that is in communication with an Internet service provider (ISP) 14 that operates to facilitate communication between the user interface 12 and the Internet domain 20. Accordingly, communications data flow 22 between the user interface 12 and the Internet 20 passes through the Internet service provider's 14 facilities.

Preferably the user interface 12 is a personal computer. However, it is appreciated that other interfaces may be used such as handheld organizers, palm computers, pocket computers, cell phones or the like that are capable of facilitating communications via open networks such as the Internet.

Referring again to FIG. 1, the Internet service provider includes at least one server 18 operative to store communications data 22 that pass through the Internet service provider 14.

A software program employed by the Internet service provider is disposed on a server 18 in communication with the Internet service provider 14. The software and server cooperate to monitor electronic communications between the user interface 12 and the Internet 20. The software program causes the communications data 22 to be stored on the server 18 when the monitored electronic communications are determined to satisfy predetermined criteria. The predetermined criteria may be provided as a word or a group of words predisposed within the software program or words selectively provided by a user of the system 10. It is appreciated that the system may be adapted to monitor criteria other than words such as images, symbols and the like.

Upon determining that the monitored communication's data 22 is inappropriate, the server 18 stores the information and then generates a violation notice 24 for sending to a content administrator 26. Preferably, the violation notice 24 includes an electronic link that allows the content administrator 26 to remotely access the stored electronic communications at the server 18 that were determined to be inappropriate communications based upon the predetermined criteria. After the content administrator 26 has reviewed the stored electronic communications at the server 18, the system 10 allows the content administrator 26 to send complaint information 28 to legal authorities 30 such that further investigation may be conducted or other appropriate action may be taken.

As mentioned briefly above, the system 10 preferably allows for a content administrator 26 to customize the predetermined criteria used by the software program for monitoring communications data 22. Furthermore, preferably the software package allows for the content administrator 26 to selectively set the system 10 up for a particular level of communications monitoring such as low, medium or high levels of monitoring. It is appreciated that the higher security levels result in a greater level of scrutiny during the monitoring of communications data 22.

As an alternative to the violation notice including an electronic link that permits a content administrator 26 to access the stored portion of the electronic communications 22 at the server 18, the violation notice may include vital information concerning particulars of the communication illustratively including the user names of parties involved in the communication, a portion of the communications, e-mail addresses, the time and date of the communications. Most preferably, each violation notice 24 includes an electronic link that allows the content administrator 26 to cause the server 18 to automatically generate and send a complaint 28 to legal authorities 30 if the content administrator determines the stored communications to be of an inappropriate nature after review.

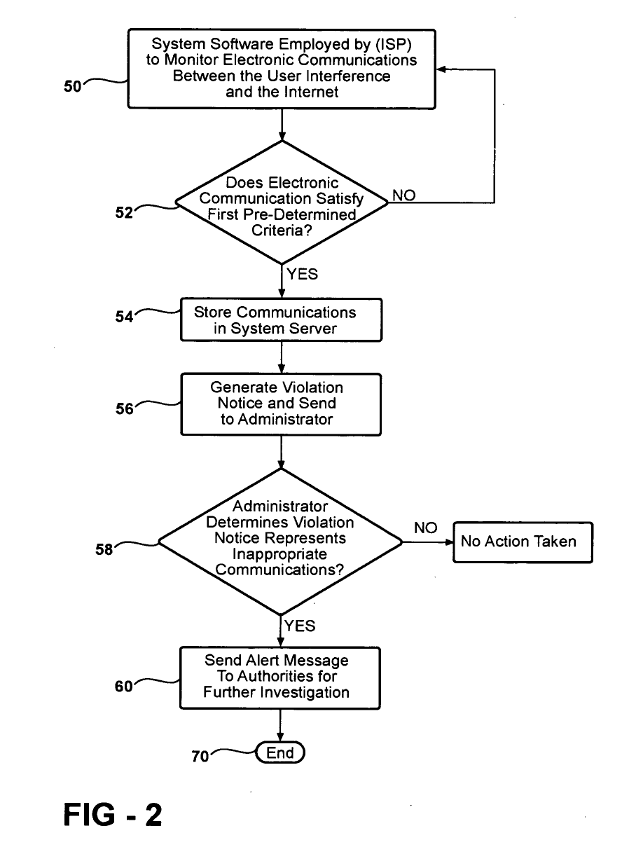

Referring now to FIG. 2, a process flow of the preferred embodiment of the Internet security system is generally illustrated at blocks 50-70.

At block 50, the system software employed by the ISP operates to monitor the communications data 22 being transmitted between the user interface and the Internet 20. The process advances from block 50 to block 52.

At block 52, the software determines whether the communications data 22 satisfies the predetermined criteria that is predisposed in the software or selectively provided by the content administrator 26. The software continues to monitor communications until the predetermined criteria is satisfied. The method of the Internet security system as according to the invention then advances from block 52 to block 54.

At block 54, the software operates to cause the server to store a portion of the entire electronic communications data 22 that satisfied the predetermined criteria, and at block 56 the system operates to generate a violation notice that is sent to the content administrator 26. The process continues from block 56 to block 58.

At block 58 the content administrator 26 receives the violation notice 24 and accesses and reviews the stored communications at the server 18 to determine whether the communications are in fact considered to be inappropriate communications. If the communications are determined to be harmless by the content administrator 26, then no action is taken and the system continues to monitor communications data 22 as according to blocks 50 and 52. If the content administrator 26 determines the communications data 22 provided in the violation notice 24 to be inappropriate, then the violation notice allows for the content administrator to cause the system to generate a complaint or alert message to be sent to legal authorities 30 by simply clicking the electronic link in the violation notice 24 (see block 60). Thereafter, the legal authorities may continue the investigation or implement other appropriate action. It is appreciated that the option to alert authorities may be provided to the content administrator upon accessing the stored communications data at the server rather than in the violation notice.

The system 10 as according to the present invention allows a content administrator 26 to access the server 18 from remote locations such that the content administrator may set up, reconfigure, modify or disable the features of the software program relative to communications data monitoring criteria and/or the security level at which the communications data 22 is to be monitored.

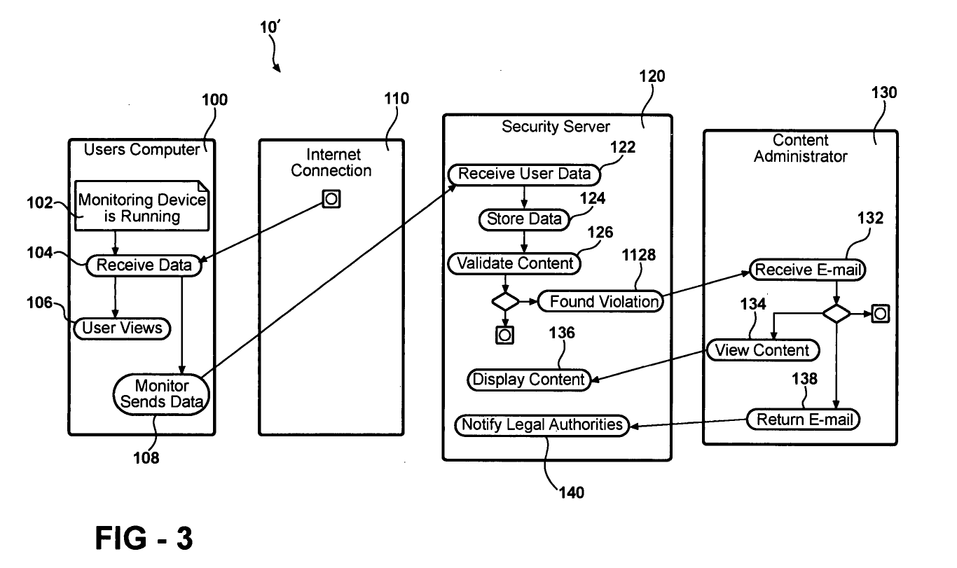

Referring now to FIG. 3, an alternative embodiment 10′ of the Internet security system as according to the invention is provided.

The system components include a user interface 100 in communication with the Internet 110, a security server 120, and a content administrator 130.

In this embodiment the software program 102 is disposed on a user interface wherein the software operates to monitor the communications data 22 between the user interface 100 and the Internet in a manner virtually unnoticed by the user of the interface 100. The user at the user interface 100 is permitted to receive data 104 and view data 106 as he or she normally would when communicating with an anonymous party at the Internet 110.

The software 102 disposed on the user interface 100 monitors the data until the communications data is considered to be of an inappropriate nature relative to a predetermined criteria as according to the invention. When the communications are determined to be inappropriate, the software operates to send a portion of the monitored data 108 to the security server 120 where the information is received 122 and stored at 124.

At the security server 120 the system 10′ operates to generate a violation notice for sending to the content administrator 130. The content administrator 130 receives the violation notice 132 and thereafter accesses the stored data 124 at the security server 120. The security server 120 displays the content 136 of the communications stored in the security server regarding the inappropriate communications. If the content administrator 130 determines the stored data to be inappropriate, then the system 10′ allows for the content administrator 130 to cause the security server 120 to generate complaint information for sending to legal authorities at 140. The security server 120 may be adapted to be accessible by law enforcement authorities for permitting the authorities to review the stored data 124 relative to inappropriate communications. Optionally, the system allows for the real-time assumption of an identity by law enforcement personnel for the purpose of investigation and response. This is useful when law enforcement has been notified of an offender and said offender has been tagged by our system as a real and dangerous threat. Law enforcement personnel can assume an identity and correspond with the offender thereby gaining evidence.

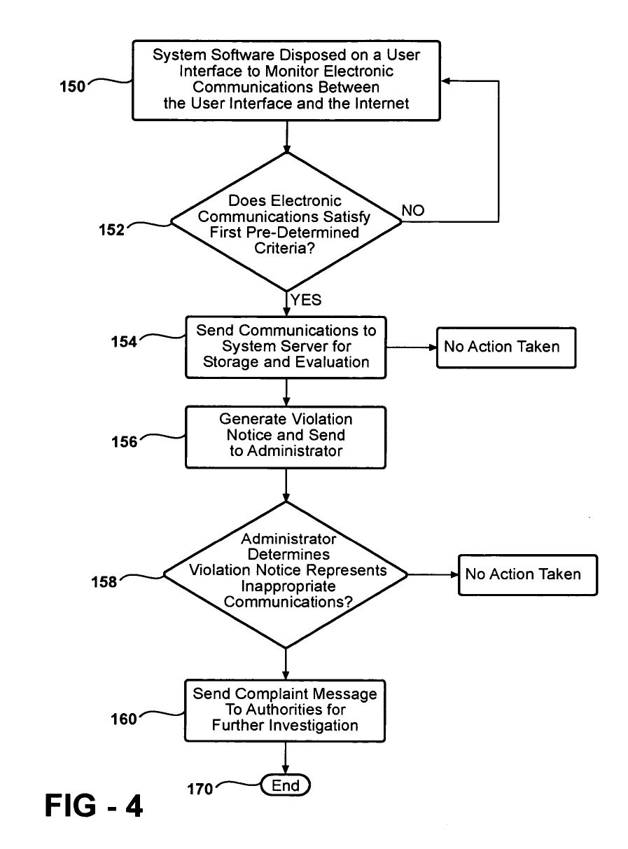

FIG. 4 illustrates a process for the alternative embodiment 10′ of the Internet security system as according to the invention. At 150 the system software disposed on the user interface monitors electronic communication between the user interface and the Internet.

At 152 the system software recognizes the electronic communications to be of an inappropriate nature based upon the predetermined criteria. At 154 a portion of the communications data that is considered to be of an inappropriate nature as according to the predetermined criteria is sent to the security server for storage. In this manner the operator at the user interface 100 cannot destroy the information as would be possible if the information were stored at the user interface 100.

At 156 the system server generates a violation notice and sends the notice to a content administrator. At 158 the content administrator is allowed to access the stored information at the security server for review. If the stored communications are considered to be inappropriate, the content administrator is allowed to cause the system server to generate a complaint message for sending to the local authorities. As described above, the content administrator preferably causes the complaint message to be generated by simply clicking an electronic link provided by the system 10′. The Internet security system of the present invention provides advantages over conventional methods of cyber surveillance such as screen scraping wherein all communications data between a user interface and the Internet are stored on a portion of the monitoring system. This method creates huge log files of communications data which may or may not contain inappropriate communications and which could potentially take hours to review when attempting to discover such inappropriate communications.

In a corporate environment the system can be implemented by installing the software on a server disposed at the corporate facility for continuously monitor all network communications over the Intranet/Internet. The security server is disposed off-site at a remote facility controlled by a network security service provider that supports the system. It is appreciated that system provides for communication with a content administrator and legal authorities as according to the foregoing.

Alternatively, the system may be implemented as a standalone system whereby the entire system resides within the corporate boundary. That is to say that a server that runs software and the security server including storage facilities operate at the corporate site.

Preferably, the present invention only stores communications that are determined to be inappropriate based on the predetermined criteria that is provided as part of the software and/or selectively provided by the content administrator. Further, the system prevents one who is alerted to his or her communication being monitored from destroying content of the electronic communications because the information is always stored remotely from the user interface at all times. Still further, the present invention allows for the content administrator to selectively review portions of the electronic communications to determine if the communications are in fact considered to be of an inappropriate nature and to thereafter automatically cause a complaint message to be sent from the system to legal authorities as necessary. The system allows for the real-time assumption of an identity by law enforcement personnel for the purpose of investigation and response.

From the foregoing, the present invention provides an Internet security system for monitoring communications between a user interface and an anonymous party communicating over the Internet/Intranet. One skilled in the art upon reading the specification may come to appreciate changes and modifications that do not depart from the spirit of the invention as defined by the scope of the appended claims.

I claim:

1. A system for use in combination with an Internet service provider for monitoring electronic communications conducted via the Internet/Intranet, the Internet service provider being in communication with a server, said system operative to store communications in the server and alert predetermined entities when the electronic communications between a user interface and the Internet are determined to be inappropriate based on predetermined criteria, said system comprising:
a user interface in communication with the Internet service provider, the Internet service provider operative to facilitate electronic communications between said user interface and the Internet;
a software program employed by the Internet service provider, said software program operative to monitor said electronic communications between said user interface and the Internet and to cause a portion of said electronic communications corresponding to inappropriate communications to be sent to the server when said electronic communications satisfy a predetermined criteria, the server operative to store said portion of electronic communications and further operative to generate a violation notice regarding said inappropriate communications; and
a content administrator in communication with the server, said content administrator operative to receive said violation notice from the server and to access said stored portion of electronic communications, said system operative to permit said content administrator to send complaint information to legal authorities when said content administrator determines said stored portion of electronic communications are inappropriate communications.

2. The system of claim 1 wherein the user interface is an interface selected from the group consisting of a computer, a personal communications system, and a cell phone.

3. The system of claim 1 wherein said predetermined criteria is a word or a group of words provided with said software program.

4. The system of claim 3 wherein said predetermined criteria is further comprised of criteria selectively provided by said content administrator.

5. The system of claim 1 wherein said software program is operative to selectively monitor communications at one of a plurality of security levels.

6. The system of claim 1 wherein said content administrator is in communication with the Internet service provider to set up, modify, or disable said software program.

7. The system of claim 1 wherein said content administrator sends complaint information to legal authorities electronically by clicking an electronic link provided in said violation notice.

8. A method for monitoring electronic communications via the Internet system for use in combination with an Internet service provider that monitors electronic communications conducted via the Internet, the Internet service provider being in communication with a server, said method operative to cause communications to be stored in the server and alert predetermined entities when the electronic communications between a user interface and the Internet are determined to be inappropriate based on predetermined criteria, said method comprising the steps of:
providing a user interface in communication with the Internet service provider, the Internet service provider operative to facilitate electronic communications between the user interface and the Internet;
disposing a software program at the Internet service provider, the software program operative to monitor the electronic communications between the user interface and the Internet;
storing a portion of the electronic communications corresponding to inappropriate communications at the server when the electronic communications satisfy a predetermined criteria;
generating a violation notice regarding the inappropriate communications at the server;
sending the violation notice to a content administrator in communication with the server;
providing the content administrator access to the stored portion of electronic communications for review; and
permitting the content administrator to cause the server to generate and send complaint information to legal authorities when the content administrator determines the stored portion of electronic communications are inappropriate communications.

9. The method of claim 8 wherein the step of permitting the content administrator to cause the server to generate and send complaint information further includes the step of providing an electronic link to the content administrator that facilitates the generation and sending of complaint information when selected by the content administrator.

10. A system for monitoring electronic communications via the Internet/Intranet, said system operative to store communications and alert predetermined entities when the electronic communications are determined to be inappropriate based on predetermined criteria, said system comprising:
a user interface in communication with the Internet/Intranet;
a software program disposed on said user interface, said software program operative to monitor communications between said user interface and the Internet and to generate a warning notice when said monitored communications are determined to be inappropriate communications based on a predetermined criteria;
a remote security server having a database and in communication with said user interface, said security server operative to receive and store said warning notice from said user interface and further operative to generate a violation notice in response to receiving said warning notice;
a content administrator in communication with said security server, said content administrator operative to receive said violation notice from said security server, said content administrator further operative to access and review said warning notice at said security server for determining whether said warning notice contains inappropriate communications; and
a complaint facilitator accessible by said content administrator, said complaint facilitator permits said content administrator to send a complaint to legal authorities when said warning notice contains inappropriate communications.

11. The system of claim 10 wherein said first and second predetermined criteria is stored in said database.

12. The system of claim 10 wherein said administrator is in communication with said security server via a computer connected to the Internet.

13. The system of claim 10 wherein said security server starts recording said information after law enforcement has been notified.

14. The system of claim 10 wherein said administrator is further operative to generate and send an investigation request to local authorities when said administrator determines said stored information is said inappropriate communications.

15. The system of claim 10 wherein said security server is selectively accessible to a law enforcement agency.

16. A system for use within corporate boundaries for monitoring electronic communications conducted via the Internet/Intranet, said system including at least one server, said system operative to store communications in the at least one server and alert predetermined entities when the electronic communications between a user interface and the Internet/Intranet are determined to be inappropriate based on predetermined criteria, said system comprising:
a user interface in communication with a first server, the first server operative to facilitate electronic communications between said user interface and the Internet/Intranet;
a software program employed by the first server, said software program operative to monitor said electronic communications between said user interface and the Internet/Intranet and to cause a portion of said electronic communications corresponding to inappropriate communications to be sent to a second server when said electronic communications satisfy a predetermined criteria, the second server operative to store said portion of electronic communications and further operative to generate a violation notice regarding said inappropriate communications; and
a content administrator in communication with the second server, said content administrator operative to receive said violation notice from the second server and to access said stored portion of electronic communications, said system operative to permit said content administrator to send complaint information to legal authorities when said content administrator determines said stored portion of electronic communications are inappropriate communications.

17. The system of claim 16 wherein the first and second server are disposed a common corporate boundary.

18. The system of claim 16 wherein the first and second server are disposed at separate corporate boundaries that are remote from one another.
